(19) United States
(12) Patent Application Publication
(10) Pub. No.: US 2021/0396408 A1
(43) Pub. Date: Dec. 23, 2021

(54) ANTI-VIRAL AND ANTIBACTERIAL AIR FILTRATION SYSTEM

(71) Applicant: Carl Saieva, Port Jefferson, NY (US)

(72) Inventor: Carl Saieva, Port Jefferson, NY (US)

(21) Appl. No.: 17/352,840

(22) Filed: Jun. 21, 2021

Related U.S. Application Data
(60) Provisional application No. 63/042,312, filed on Jun. 22, 2020.

(51) Int. Cl. F24F 8/192; F24F 8/108; F24F 8/22; F24F 13/28

(52) U.S. Cl. CPC F24F 8/192; F24F 8/108; B03C 3/017; F24F 13/28; F24F 8/22

(57) ABSTRACT

An improved high-efficiency electrostatic air filter device implements a dust collection function and incorporates a material that captures and that is toxic to viruses/bacteria and causes viruses and bacteria to be rendered harmless by contact with this material. The device is composed of a charging section having a conductive antiviral media to charge any particles in the gas with a high electric voltage and a collecting section which contains or is composed of conductive material which has antiviral/antibacterial properties and a surface of opposite polarity or lower potential that will cause the aforementioned charged particles to adhere to the toxic material as the gas flows through or around the media. The collection section is formed with or coated by an inactivating material that inactivated pathogens when physically contacted.

### CROSS-REFERENCE TO RELATED APPLICATIONS

This application derives the benefit of the filing date of U.S. Provisional Patent Application No. 63/042,312, filed Jun. 22, 2020 the contents of the provisional application are incorporated by reference in this application.

### BACKGROUND OF THE INVENTION

This invention relates to electrostatic air filter devices. More particularly, the invention relates to an electrostatic air filter device for use in the cleaning of air in a space, which device has a very high efficiency and is capable of removing pathogens, particularly viruses and bacteria, and rendering the pathogens harmless as well as, removing dust, smoke and allergens.

Electrostatic filter devices are known. High-efficiency particulate air (HEPA) filters, also known as high-efficiency particulate absorbing, and high-efficiency particulate arrestance filters, defines the standard for air filter efficiency. HEPA filters are used in applications that require contamination control, such as the manufacturing of disk drives, medical devices, semiconductors, nuclear, food and pharmaceutical products, as well as in hospitals, homes and vehicles.

HEPA filters are typically composed of a mat of randomly arranged fibers. Common fibers used therein are made of fiberglass and possess diameters between 0.5 and 2.0 micrometers. HEPA filter functions are affected by fiber diameter, filter thickness and thee velocity. For that matter, an air space between HEPA filter fibers is typically much greater than 0.3 μm. Unlike membrane filters at this pore size, where particles as wide as the largest opening or distance between fibers cannot pass in between them at all, HEPA filters are designed to target much smaller pollutants and particles. These particles are trapped (they stick to a fiber) through a combination of mechanisms: diffusion, interception and impaction.

Wilkes, et al., THE BACTERIAL AND VIRAL FILTRATION PERFORMANCE OF BREATHING SYSTEM FILTERS, Anaesthesia, 2000, 55, pages 458-465, describes the bacterial and viral performance of breathing system filters (either pleated hydrophobic or electrostatic) using test method specified in the draft European standard for breathing system filters, BS EN 13328-1. Table 1 identifies the filter and Table 2 identifies the sizes of particles of microbes used in the study with pathogenic microbes. The test arrangement is set out in FIG. 1 therein. The study demonstrated that pleated hydrophobic membrane filters have certain benefits over electrostatic filters, but that “the necessity of choosing a breathing system filter with a high filtration performance remains controversial.”

So, as suggested by Wilkes, et at, while conventional HEPA filters do have a high dust-collecting efficiency, and do physically block particles in the gas stream, they nevertheless permit the passing of pathogens including viruses and bacteria, or contains the pathogens while allowing them to remain viable. As such, the conventional HEPA filter itself provides a scaffolding that could facilitate the growth and dispersion of the viruses and bacteria. When utilized in air-flow system, such conventional HEPA filters have the potential for sending the viruses and bacteria to remote areas serviced by the system.

### BRIEF SUMMARY OF THE INVENTION

The present invention overcomes the shortcomings of known arts, such as those mentioned above.

The invention provides an inventive filter device and method of treating air potentially contaminated with pathogens, i.e., air that may contain viruses and bacteria, which not only removes but also renders the viruses and bacteria harmless. The advantages of such an inventive filter device and method are self-evident. The inventive filter device and method operate to maintain an environment supplied by air so filtered substantially airborn virus and bacteria free. The inventive filter device and method may be deployed in hospitals, medical facilities, schools, etc., i.e., essentially any environment where a presence of air borne pathogens such as viruses and bacteria present a danger to individuals, healthy or ill. Particularly in these current times and fears of COVID 19, such contaminants must be removed from air within a particular environment that individuals must breathe, and preferably destroyed in the process.

In an embodiment, the invention provides an electrostatic air filter (device), or electrostatic air filter system, that captures, treats and destroys air-borne pathogens including viruses and bacteria with high efficiency and safety. The inventive electrostatic air filter device (or electrostatic air filter system), preferably is used in conjunction with a pre-filter, and/or UV lighting and/or other filter materials, which, as known to the person of ordinary skill in the art, that if utilized, provide filter flexibility allowing the system to maximize the volume of air treatment per unit time and the speed of air treatment per unit time. For that matter, using the inventive electrostatic air filter device, such as by practicing the inventive method, minimizes the potential of cross contamination by pathogens extracted in view of its enhanced ability to destroy the pathogens collected; the inventive air filter device is highly efficient and free of the disadvantages of existing HEPA filter systems.

In another embodiment, the inventive air filter device is configured to treat and destroy air-borne particles and pathogens, including viruses and bacteria, with high efficiency and safety, and to do so over a very long life. The inventive air filter device is simply constructed to operate for an extended period of time without requiring any troublesome calibration, complicated cleaning operations or maintenance work. The inventive air filter device is configured to be cleaned and put back into service quickly The filter can easily be configured with surface contacts to establish the energizing and collecting components of the filter in one easily removable assembly. This permits the exchange or cleaning of the filter to a few minutes, thereby minimizing air system downtime. For that matter, the inventive air filter device is formed as a compact unit, device or system, and in view of its simple nature, can be retrofitted into existing air handling systems, such as used in commercial and residential buildings. Of course the inventive filter device can be built into new air handling products, including new HVAC systems, portable air conditioners, portable terminal air conditioners (PTACs), respirators and portable personal protective equipment for medical workers, without limitation. This avoids the costs associated with, for example, for refitting an HVAC system to accommodate a much larger container for a HEPA or high particle filter

During its operation, the inventive electrostatic air filter device extracts suspended particles and pathogens, including viruses and bacteria, in the gas to be treated (for example, air). In a preferred embodiment, a first conductive mesh screen is electrostatically charged before the gas (air) is passed through. Particles, viruses and bacteria present in the air flow become charged or adhere as they pass through the first conductive screen (which is typically copper, but not limited to copper) through an air space or dielectric, arranged in an air flow direction after the first conductive mesh screen. The charged particles that have passed through the first conductive mesh screen, are collected on the surface of a collecting media, such as a second conductive mesh screen that is at a lower or zero voltage potential when compared to the electrostatic voltage potential of the first conductive mesh screen. For that matter, the charge also can aid in the capture of particles on a prefilter or on a conductive material that is coated with an antiviral coating, which may be organic or inorganic according to need.

As importantly, the second conductive mesh screen, in addition to its collection function, also is either formed with a conductive material that can inactivate pathogens on physical contact, such as copper, copper compounds, nickel compounds, brass, silver compounds, etc. (referred to hereinafter as “inactivating, materials”). Warnes, et al., HUMAN CORONAVIRUS 229E REMAINS INFECTIOUS ON COMMON TOUCH SURFACE MATERIALS describes that the inactivating materials destroy the viral genomes and irreversibly affect virus morphology on contact with exposure, including Human Coronavirus 229E. The contact and collection of the particles, viruses and bacteria on/by a downstream electrode (i.e., the second conductive mesh screen), which is made of or coated with an inactivating material that is toxic to the viruses and bacteria, destroying the particles, viruses and bacteria.

Depending on the application, it may be necessary for the inventive filter device to capture all contaminants in a single pass, where under other circumstances it is not necessary to capture all contaminants in a single pass, such as an application where the treated area air is recycled through the air system. A continual reduction of the contaminants (including pathogens) over time and recycling of the area air is sufficient. In some applications, however, the treated air must have all contaminates (including pathogens) removed in a single pass. This requirement is found, for example, in a HVAC system that takes air from one area, treats it, and distributes the air to remote areas; also, personnel protection equipment is typically configured to remove all contaminants prior to delivering the treated air to the user. In such single filter systems, any remaining contaminants passing through the inventive filter may be captured on a final particulate filter or another set of the inventive filter and exposed to UVC, which quickly neutralizes both viruses and bacteria, independent of contact with the inactivating material coating. The final particulate filter and UVC exposure ensures that there are no active contaminants, including airborne pathogens in the air system under treatment by the inventive filter and/or method. The UVC energy, or an activated charcoal post filter, or an activated carbon filter are preferable in in high air flow systems, as same also neutralizes any excess ozone generated, and any volatile organic compounds (VOCs).

The invention also includes methods of maintaining a PTAC or HVAC air flow system substantially free of airborne viruses, bacteria and other pathogens. The method is a high efficiency filtration method of electrostatically removing particles, viruses and bacteria, suspended within a gas by electrically charging the particles, naturally pre-charged particles, viruses and bacteria in the vas and then electrostatically filtering the charged particles, viruses and bacteria from the gas with an electrostatic filter media of opposite or lower potential. A high voltage electrostatic field typically of at least one kilovolt on the upstream electrode and charging these particles, viruses and bacteria so that they are deposited and adhere onto the surface of the antiviral/antibacterial downstream oppositely charged filter (the second conductive mesh screen). For that matter, an inherent pathogen-killing character of the inactivating material (e.g., copper) from which the second conductive mesh screen is formed, or coated by, kills pathogens on contact with the inactivating material. That is, the suspended charged particles, viruses and bacteria are collected on the downstream surfaces of the differential potential filter medium (the second conductive mesh screen) from the upstream high electrostatic voltage electrode (the first conductive mesh screen). The size or magnitude of the field should be commensurate with the flow rate and mesh size, that is, if there is a very high flow rate, the field should be high enough to effectively polarize the fast moving particles to effect filtering. Alternatively, the higher field may generate ozone for additional disinfection capability, to accommodate increased air flow.

The differential potential filter medium (or second conductive mesh electrode), which has an electrostatic voltage potential that is opposite or lower than that of the first conductive mesh screen, contains a material or is made from a material that renders the particles, viruses and bacteria harmless (i.e., inactivated), such as copper, nickel, silver, brass and compounds including certain percentages of same, that irreversibly affect or are otherwise toxic to viruses and bacteria, rendering them harmless in a short period of time. The upstream pre-charging means (first electrode formed as the first conductive mesh screen) is operable for pre-charging the suspended particles with a negative charge or can attract already positively-charged particles and render them inactive. The downstream electrode (second electrode formed as the second conductive mesh screen, comprising, the inactivating material, or a coating of same) of the electrostatic filter preferably has a positive or zero (ground state) or lower than zero potential charge to capture (and kill if necessary) the negatively charged particles. When the captured pathogens are exposed to the inactivating material of the second mesh screen, the pathogens are inactivated or otherwise immobilized or destroyed. Additionally, a UVC energy source may be placed in the airstream of the electrostatic filter to irradiate the air flow, and the surface of a final particulate filter may be relied upon to expedite the neutralization of viruses and bacteria that accumulate on the filter surfaces. For that matter, an activated carbon filter also may be interposed in the air flow path.

### BRIEF DESCRIPTION OF THE DRAWINGS

Further features and advantages of the invention will become apparent from the description of embodiments that follows, with reference to the attached figures, wherein:

FIG. 1 depicts a filter device constructed according to the inventive principles;

FIG. 2 depicts an exploded perspective view of the filter device depicted in FIG. 1;

FIG. 3 depicts an air-handier unit installed in a commercial or residential structure, the air handler unit modified to include a filter device of the invention in an upper portion of the air-handler unit;

FIG. 4 depicts an inner portion of a portable air conditioner, or a packaged terminal air conditioner (PTAC) (an air flow system), or standalone air purifier in which an inventive filter device is included to destroy airborne bacteria and virus as the air is conditioned by the filter device and recirculated by the device:,

FIG. 5 depicts an alternative embodiment of an inventive filter device 10″, as compared to the filter devices depicted in FIGS. 1-4; and

FIG. 6 depicts a IP TAC which may include any of the inventive filter devices.

### DETAILED DESCRIPTION OF THE INVENTION

The following is a detailed description of example embodiments of the invention depicted in the accompanying drawings. The example embodiments are presented in such detail as to clearly communicate the invention and are designed to make such embodiments obvious to a person of ordinary skill in the art.

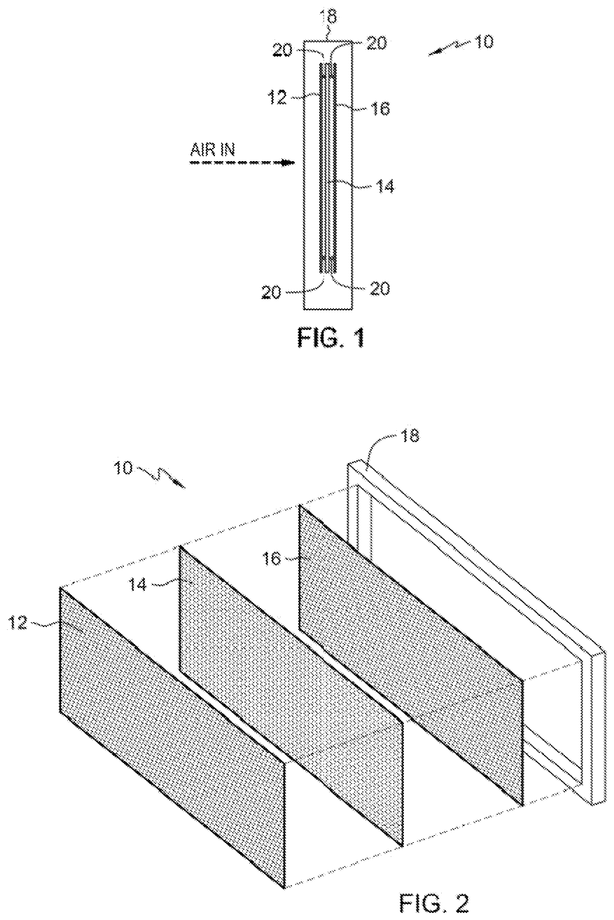

In its most basic form, the invention includes a filter device 10, as shown in FIG. 1. Filter device 10 is an electrostatic air filter device (or system), that treats and destroys air-borne particles, including pathogens such as viruses and bacteria that pass through the filter device 10 in the air flow direction (see arrow) with high efficiency and safety. The inventive electrostatic filter device 10 comprises a first conductive anti-viral mesh screen 12, a dielectric mesh spacer 14 (or a significant air space to prevent premature discharge of the charge supporting the electrostatic field) and a second antiviral conductive mesh screen 16. The first conductive mesh screen 12, the dielectric mesh spacer 14 (or sufficient “spacer” air space) and the second conductive mesh screen are contained in a frame 18. The first and second conductive mesh screens 12, 16 can be attached to the dielectric mesh spacer or spaced be 14 using insulated standoffs 2( )or a suitable air space. Sizing and spacing of filters is calculated to accommodate air flow and dielectric or air space requirements of the necessary electric field. Generally, each filter device 10 requires about 12 standoffs 20, but may require more or less. FIG. 2 presents an exploded perspective view of the filter device depicted in FIG. 1.

The first conductive mesh screen is electrically connected to an electrostatic generator (not shown in FIG. 1), that provides a negative electrostatic field across the first conductive mesh screen 12. The voltage generated is preferably in a voltage range typically starting at about 1 kilovolt and up. This variation is adjusted based on the operating parameters of the system. Higher volumetric air systems would require contaminant capture to be performed quickly without reducing the air flow significantly. The adjustments can made are to increase the size of the mesh to permit greater air flow, this in turn, would require an increase of the voltage of the charging screen to establish the required electrostatic field to span the void of the mesh and properly pre-charge the contaminants. As particles, such as pathogens including viruses and bacteria, pass through the mesh openings of the first conductive mesh screen 12, the particles become charged or adhere. The charged airborne particles that then pass through the mesh of the dielectric mesh spacer 14 and are collected by the much lower (or oppositely) charged second conductive mesh screen 18. The charged particles that pass are highly attracted to the second conductive mesh screen 18.

In a preferred embodiment, the mesh size of the first conductive mesh screen 12 and the second conductive mesh screen 16 are 20×20. The mesh size of the dielectric mesh spacer 14 is sized to support and separate the conductive screens for the air flow and electrostatic filed required. Please note, however, that the inventive filter system 10 is not limited to conductive mesh screens and dielectric spacer mesh spacers, respectively. The mesh size should not overly restrict air flow through the conductive mesh and dielectric screens. A 20×20 mesh screen size results in a loss of air flow of about 4% at 350 cubic feet per minute (CFM) For that matter, the dielectric mesh spacer 14 might be first hard-wired or otherwise affixed to the frame 18 and the first and second conductive mesh screens 12, 16 can be in direct contact but not necessary to the conductive screens.

As importantly, while the FIG. 1 embodiment depicts a filter device 10 with two conductive mesh screens 12, 16 separated by dielectric mesh spacer 14 and standoff's 20 (or alternatively, an air space), same was presented for exemplary purposes only, and is not meant to be limiting. According to the inventive concept, the filter device can support additional conductive mesh screens, and corresponding dielectric mesh spacers through which air is conditioned, as long as average air flow is not substantially impeded (or additional air space is provided). For example, third and fourth conductive mesh screens arranged to function as the first and second conductive mesh screens, with a spacer in between (the spacer could be a dielectric such as dielectric spacer 16, or, just air (space)). The inventive filter devices 10 may be incorporated within known air flow systems, to efficiently and safely maintain a body of air contained in a physical volume or space fed or conditioned by the air flow system.

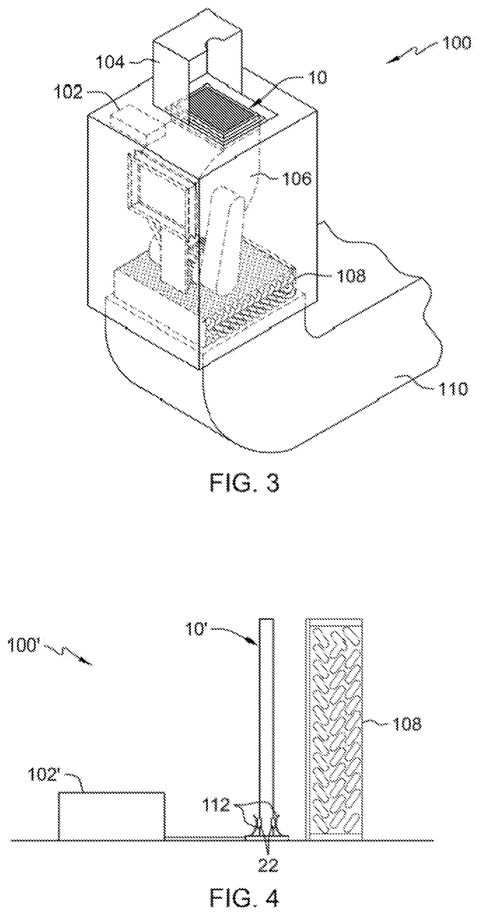

FIG. 3 depicts an air-handler unit 100 installed in a commercial or residential structure, the air handler unit modified to include a filter device 10 of the invention in an upper portion of the air-handler unit. The air handler unit also includes and electrostatic electrical generator 102, a plenum 104 from which air conditioned by the filter device 10 is delivered to an interior of a residence or commercial building, a blower 106, an A-frame/evaporator coil 108 and return air-duct 110 through which interior room air passes for conditioning. The electrostatic electrical generator 102 is electrically connected to the filter device 10, and controls the electrostatic voltage across the first conductive mesh screen 12. The first conductive mesh screen 14 is electrically isolated. The second conductive mesh screen is at lower potential than the potential of the first conductive mesh screen 12 (or grounded, alternatively).

The voltage generated is preferably in a voltage range typically starting: at 1 kilovolt and up to several thousand volts, preferably about 5 kv 5000 v (or 5 kv). The electrostatic generator may be a simple step up voltage converter, with means for stepping up a voltage from the air system into the preferred voltage range and polarity. Typically, the electrical generator 102 is a simple device that takes a low or line voltage input AC or DC low voltage input, AC or DEC. For that matter, the electrostatic generator may have an AC supply, where the AC electrical energy is stepped up to the desired electrostatic voltage and stepped up to the desired electrostatic voltage. The AC voltage inputs may be 24 v AC, 120 v AC, 220 v AC, etc., without limitation.

As particles, such as pathogens including viruses and bacteria, pass through or adhere to the mesh openings of the first conductive mesh screen 12, the particles become charged. The charged airborne particles then adhere to the first conductive mesh or pass through a space, such as that space filled with dielectric mesh spacer 14 (the spacer could be air), and collected by the much lower charged second conductive mesh (or oppositely-charged mesh) screen 18. The charged particles are highly attracted to the second conductive copper mesh screen 18. And as explained above, the second electrode of conductive mesh screen 16 is formed also with inactivating material (i.e., copper, copper compounds, nickel compounds, brass, silver compounds, etc.), or a conductive mesh screen is coated with the inactivating material, so that when collected on the first or second conductive mesh screen, the pathogens contact and are inactivated or otherwise destroyed by the contact with the inactivating, materials

The inventive filter can be adapted in most known air flow systems. FIG. 4 depicts an inner portion of a portable air conditioner, or a packaged terminal air conditioner (PTAC) 100′ (an air flow system), or a standalone air purifier in which a filter device 10′ is included (hereinafter referred to as “PTAC 100′”) so that the PTAC performs not only as intended as a PTAC, but also implements the inventive method of destroying airborne bacteria and virus as the air is conditioned by the filter device 10 and recirculated by the PTAC.

The filter device 10′ is arranged at the “air in” end of the PTAC 100′. Filter device 10′ includes a pair of contacts 22 fir receiving a high electrostatic voltage across the first and second conductive mesh screens 12, 16. A pair of spring loaded contacts 112 are physically attached to a lower part of the PTAC 100′ base or frame. The spring loaded contacts 112 are electrically connected to an electrostatic supply or generator 102′ to supply the isolated high electrostatic voltage to the spring loaded contacts 112. The spring loaded contacts grasp the filter device 10 and supplies the electrostatic voltage across contacts 22 of the filter device 10′ or the filters can be hard wired to achieve the desired electrostatic fields.

The inventive air filter, preferably is used in conjunction with a pre or post filter, and/or UV or UVC lighting and/or other filter materials (not explicitly shown in FIG. 4). As known to the person of ordinary skill in the art, such pre or post filter, and/or UV or UVC lighting and/or other filter materials, provides filter flexibility, allowing the air flow system in which it is deployed (such as PTAC 100′) to maximize the volume of air treated per unit time and/or the speed of air treated per unit time. For that matter, using the inventive air filter (device), such as by practicing the inventive method, minimizes the potential of cross contamination in view of the filter device's s enhanced ability to destroy bacteria and viruses. The inventive air filter device is highly efficient and free of the disadvantages of existing systems. Likewise, the inventive air filter and air filter systems reduce energy costs by minimizing the air flow restriction of the system.

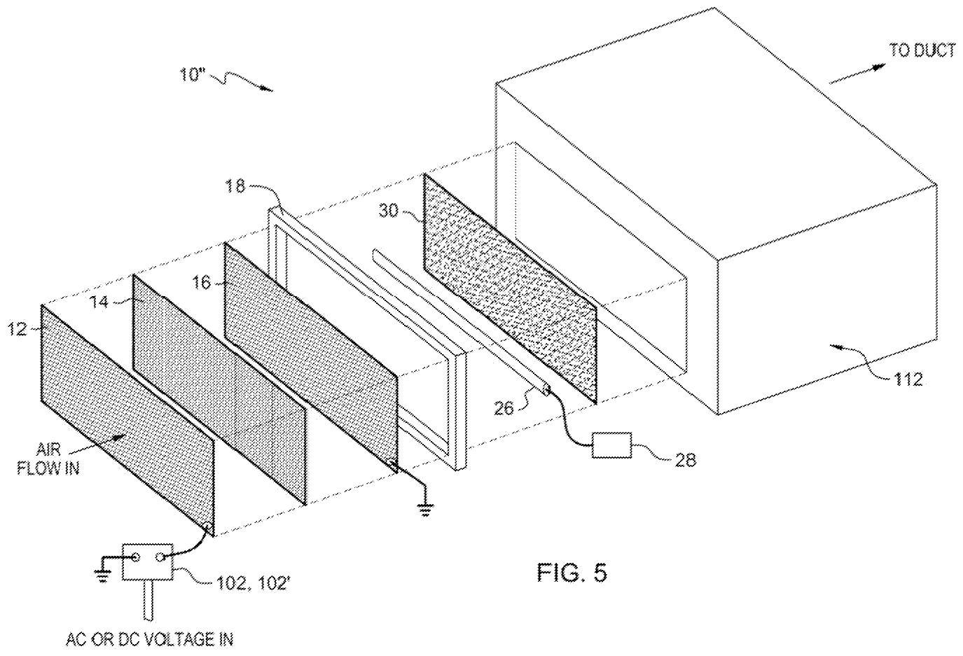

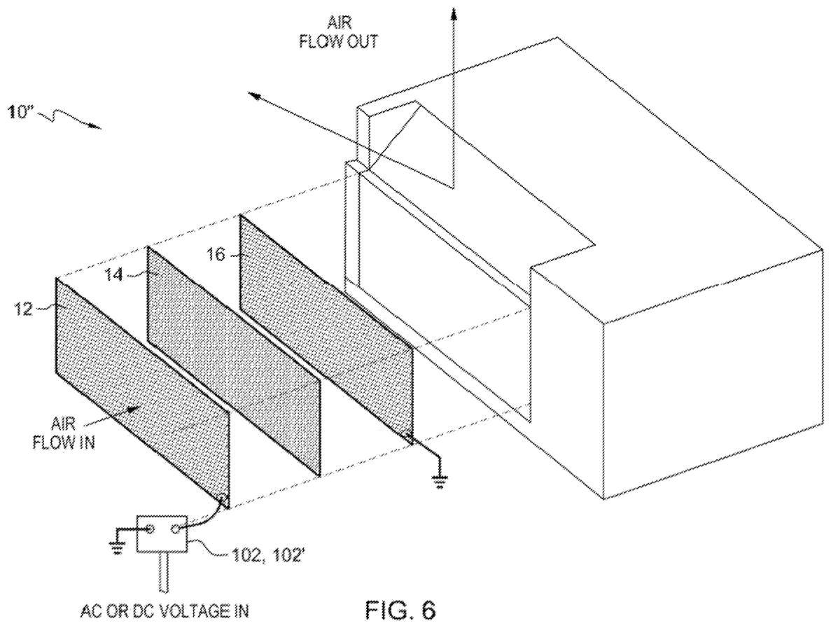

FIG. 5 depicts an alternative embodiment of an inventive filter device 10″, as compared to the filter devices 10 and 10′ depicted in FIGS. 1-4. Filter device 10″ in it basic form is an electrostatic air filter device (or system), that treats and destroys air-borne particles, including pathogens such as viruses and bacteria, which pass through the filter device in the air flow direction (see arrow “air flow in”) with high efficiency and safety. The inventive electrostatic filter device 10″ comprises a first conductive mesh screen 12, a dielectric mesh spacer or air space 14 and a second conductive mesh screen 16. The first conductive mesh screen 12, the dielectric mesh spacer or grid or standoffs 14 and the second conductive mesh screen are contained in a frame 18. Preferably, the first and second conductive mesh screens 12, 16 can be but are not necessarily attached to the dielectric mesh spacer 14 or using insulated standoffs or air space 20. The dielectric mesh spacer 14, however, may be omitted as long as the space and electrical isolation between the first 12 and second 16 conductive mesh screens is appropriate.

The first conductive anti-viral mesh screen 12 is electrically connected to an electrostatic generator 102, 102′, that provides an isolated, high voltage electrostatic field across the first conductive mesh screen The voltage generated is preferably in a voltage rat me of between 500 volts to 10 kilovolts, preferably 5 kv. As particles, such as viruses and bacteria, approach the mesh openings of first conductive antiviral mesh screen 12, the particles become charged or otherwise adhere to the antiviral mesh. The charged airborne particles that pass through the mesh of the dielectric mesh spacer 14 (or open space if the dielectric spacer is omitted) and are collected by the much lower potential second conductive antiviral mesh screen 16 (or ground). The charged particles are highly attracted to the second conductive mesh screen 16, due to preferably opposite (or lower potential) charge. Also, the second conductive antiviral mesh screen 16 preferably is formed with an inactivating material, such as copper, copper compounds, nickel compounds, brass, silver compounds, organic compounds, etc. (referred to hereinafter as “inactivating materials”).

The inventive embodiment of FIG. 5 can include a UVC lamp 26 arranged in an air flow direction after the second conductive mesh screen 16 and frame 18. UV germicidal bulbs emit very short ultraviolet wavelengths from 100 to 280 nanometers that damage the DNA of bacteria, viruses, and other pathogens. UVC light does this by damaging the nucleic acid in microorganisms so they cannot unzip for replication. As the UVC radiation is absorbed into the cells they become unable to reproduce or multiply to infectious numbers and are considered inactive or dead. UVC germicidal wavelength at 260 nm is the most effective to kill harmful microorganisms in the air, water and on surfaces. A power supply 28 may be connected to the UVC lamp 28 within the filter device 10″, to power same. The UVC lamp 26 irradiates and kills airborne viruses and bacteria, in cooperation with the function performed by the electrostatic mesh screen 16.

A particulate filter 30 is arranged after the UVC lamp 26, to substantially remove any remaining particles from the air flow passing through, or attached to, the second mesh screen 16. The particulate filter 30 may embody any particulate filter, which as known to the person of ordinary skill in the art, that will not substantially reduce air flow in any air flow system in which the filter device is deployed. Once past the particulate filter, the air flow typically will enter a HVAC unit 112 (or PTAC flow pathway).

FIG. 6 depicts a PTAC 100″, which may include any of filter devices 10, 10′ or 10″. As should he clear from the figure, the air flow enters PTAC and passes through the first conductive mesh screen 12 and charged, passes through the space or dielectric spacer 14 and collected at the second conductive mesh screen 16. If there is a UVC light 26 and power supply 28 in the filter device (10, 10′, 10″) implemented, there is a secondary killing function implemented by the light in addition to the electrostatic killing. Likewise, if there is a particulate filter 30, the air is further filtered prior to being exhausted in the direction of air flow out arrows, as shown. Also, if the second conductive mesh screen 16 is formed of, or coated by an inactivating material, pathogen contact therewith further supports pathogen destruction.

In a preferred embodiment, the mesh size of the first conductive mesh screen 12 and the second conductive mesh screen 16 are 20×20 20×20. The mesh size of the dielectric mesh or grid spacer 14 large enough to prevent air flow restriction while maintaining the necessary spacing of the first and second mesh. Please note as stated earlier, however, that the inventive filter system 10 is not limited to conductive mesh screens and dielectric spacer mesh spacers to ½ inch×½ inch or similar to support and prevent contact of the screens at the applied air flow, respectively. The mesh size should not overly restrict air flow through the conductive mesh and dielectric screens. Dielectric should be isolated from charge and ground state, so, while the above are preferred, the mesh screen size may be any N×N, where N is between 1 and 500.

As will be evident to persons skilled in the art, the foregoing detailed description and figures are presented as examples of the invention, and that variations are contemplated that do not depart from the fair scope of the teachings and descriptions set forth in this disclosure. The foregoing is not intended to limit what has been invented, except to the extent that the following claims so limit that.

What is claimed is:

1. A filter device for use in air flow systems, comprising:
a first, conductive antiviral mesh screen;
a second conductive antiviral mesh screen, spaced apart and electrically isolated from the first conductive mesh screen, and formed with or coated with an inactivating antiviral material; and
an electrostatic voltage generator for providing an isolated, high electrostatic potential across the first-mesh screen;
wherein, a magnitude of the isolated, high electrostatic potential across the first conductive mesh screen is greater than a magnitude of an electrostatic potential of the second conductive mesh screen; and
wherein, airborne particles, including pathogens such as viruses and bacteria, within an air flow entering the filter device, are charged or attracted by the electrostatic potential of the first conductive antiviral mesh screen and then captured, due to the charged state of the airborne particles, by the second conductive antiviral mesh screen, and inactivated by contact with the inactivating antiviral material.

2. The filter device for use in air flow systems of claim 1, further comprising a dielectric spacer element or air space operating to physically and electrically separating the first and second conductive mesh screens.

4. The filter device for use in air flow systems of claim 2, wherein the dielectric spacer element is a dielectric grid, with a grid size in a range that mechanically supports and separates the first and second screen for the applied air flow and electrostatic filed.

4. The filter device for use in air flow systems of claim wherein the electrostatic voltage generator requires a voltage supply from the unit, and steps up to the electrostatic voltage to around 1 kilovolt to 5 kilovolt, or higher, at a proper polarity.

5. The filter device for use in air flow systems of claim 1, wherein the filter device includes a first electrical contact connected to the first conductive mesh screen and a second electrical contact connected to the second conductive mesh screen.

6. The filter device tint use in air flow systems of claim 5, further comprising spring loaded contacts for holding the filter device, wherein a first spring loaded contact electrically connects the first electrical contact of the first conductive mesh screen to the electrostatic voltage generator and a second spring loaded contact electrically connects the second electrical contact of the second conductive mesh screen to ground.

7. The filter device for use in air flow systems of claim 1, wherein the first and second copper mesh screens have a mesh size in a range typically of about 10×10 1×1 per square inch and 200×200 500×500 per square inch.

8. The filter device for use in air flow systems of claim 7, wherein the first conductive mesh screen displays a mesh size of 20×20 20×20 per square inch.

9. The filter device for use in air flow systems of claim 8, wherein a mesh size of the second conductive mesh screen is 20×20 20×20 per square inch.

10. The filter device for use in air flow systems of claim 1, wherein a mesh size of the first and second conductive mesh screens is varied based on the electrostatic potential and air flow arranged across the first conductive mesh screen.

11. The filter device for use in air flow systems of claim 1, further comprising a UVC light source for exposing an air flow and the second conductive mesh screen to UVC light.

12. The filter device for use in air flow systems of claim 11, further comprising a particulate filter for filtering the air flow exposed to the UVC light.

13. A filter system for removing and destroying airborne pathogens from a air flow system in which the filter system is installed and operational, the filter system comprising:
a filter system frame configured for installation in the air flow system; and
the filter device for use in air flow systems of claim 1.

14. A packaged terminal air conditioner (PTAC) for conditioning air including removing and destroying airborne pathogens from air flowing through the PTAC, the PTAC comprising:
a PTAC frame;
a filter device; and
an air flow system for receiving air flowing out of the filter device;
wherein, the filter device comprises:
a first conductive mesh screen;
a second conductive mesh screen, spaced apart and electrically isolated from the first conductive mesh screen, and formed with or coated with an inactivating antiviral material; and
an electrostatic voltage generator for providing an isolated, high electrostatic potential across the first conductive mesh screen;
wherein, a magnitude of the isolated, high electrostatic potential across the that conductive mesh screen is greater than a magnitude of an electrostatic potential of the second conductive mesh screen; and
wherein, airborne particles, including viruses and bacteria, within an air flow entering the filter device are charged or captured by the electrostatic potential of the first conductive mesh screen and then captured, due to their charged state, by the second copper mesh screen, and destroyed by contact with the inactivating antiviral material.

15. The PTAC of claim 14, further comprising a dielectric spacer element or air space included and arranged to physically and electrically separating the first and second conductive mesh screens.

16. The PTAC of claim 14, further comprising spring loaded contacts for holding the filter device, wherein a first spring loaded contact electrically connects the first conductive mesh screen to the electrostatic voltage generator and a second spring loaded contact electrically connects the second conductive mesh screen to ground.

17. The PTAC of claim 14, further comprising a UVC light source for exposing an air flow exiting the second conductive mesh screen to UVC light.

18. The PTAC of claim 17, further comprising a particulate filter or surface for filtering the air flow or surfaces exposed to the UVC light.

19. A commercial or residential heating, ventilation and air conditioning (HVAC) system for conditioning air including removing and destroying airborne pathogens from air flowing through the HVAC system, the HVAC system comprising:
a filter device; and
an air flow system for receiving air flowing out of the filter device;
wherein, the filter device comprises:
a first conductive antiviral mesh screen;
a second conductive antiviral mesh screen, spaced apart and electrically isolated from the first conductive mesh screen, and formed with or coated with an inactivating antiviral material; and
an electrostatic voltage generator for providing an isolated, high electrostatic potential across the first conductive antiviral mesh screen;
wherein, a magnitude of the isolated high electrostatic potential across the first conductive mesh screen is greater than a magnitude of an electrostatic potential of the second conductive antiviral mesh screen; and
wherein, airborne particles, including viruses and bacteria, within an air flow entering the filter device are charged by or attracted by the electrostatic potential of the first conductive mesh screen and then captured, due to their charged state, by the second conductive mesh screen, and destroyed by contact with the with the inactivating antiviral material.

20. The commercial or residential heating, ventilation and air conditioning (HVAC) system of claim 19, further comprising a UVC light source for exposing an air flow exiting the second conductive mesh screen to UVC light.

21. The commercial or residential heating, ventilation and air conditioning (HVAC) system of claim 20, further comprising a particulate filter or surface for filtering the air flow exposed to the UVC light.
